(19) United States
(12) Patent Application Publication
(10) Pub. No.: US 2006/0281500 A1
(43) Pub. Date: Dec. 14, 2006

(54) Mobile telecommunication apparatus having antenna assembly compatible with different communication protocols

(75) Inventors: Cheng-Wen Huang, Taipei (TW); Jung-Kuan Tseng, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/151,428

(22) Filed: Jun. 14, 2005

(51) Int. Cl. H04B 1/38

(52) U.S. Cl. 455/575.1; 455/90.3

(57) ABSTRACT

A mobile phone includes an antenna assembly having first, second, third and fourth antenna metal strips. The first, second, third and fourth antenna metal strips are respectively compatible to the digital phone system, GSM (Global Sim Mobile), GPS (Global Positioning System), WLAN (Wireless Local Area Network).

### FIELD OF THE INVENTION

The present invention relates to a mobile telecommunication apparatus (such as a mobile phone), more particularly to an antenna assembly that is employed in the mobile phone and that is compatible with different communication protocols.

### BACKGROUND OF THE INVENTION

Mobile phones, smart phones and PDAs (personal digital assistants) are some of the handy articles that facilitate a busy person of nowadays to accomplish some of his daily works, like noting down the business appointments, tracking the lists of stocks, making simple calculation, storing addresses of the clients, and transmitting e-mails.

Referring to FIG. 1, a conventional mobile telecommunication apparatus 2 (simple a mobile phone) is shown to include a main body 4 having a communication module 10, a cover member 8 for covering the main body 4, a battery 6 for supplying power source to the communication module 10, and an antenna assembly 12 electrically coupled to the communication module 10 for transmitting and receiving radio signals.

As illustrated in FIG. 2, the antenna assembly 12 includes a base plate 14 and an antenna metal strip unit 16 fabricated on the base plate 14. The base plate 14 is generally made from plastics of relatively stiffness. In order to be compatible with different radio frequency and one-quarter-wavelength principle, the configuration of the antenna metal strip unit 16 may differ one from the other according to the type of mobile phones and its printed circuit board.

The mobile phones of today operate under several communication protocols, such as GSM (Global Sim Mobile), GPS (Global Positioning System), WLAN (Wireless Local Area Network) and etc. The WLAN includes IEEE 802.11a, IEEE 802.11b, IEEE 802.11g and bluetooth protocol, each of which has specific bandwidth and its distinguishing characteristic.

In case, the mobile phone of today is required to be constructed in such a manner to possess multiple functions, such a receiving TV digital signals and sending e-mail. The communication module 10 of the mobile phone 2 should be provided with the antenna assembly adapted to be compatible with the aforesaid four communication protocols. It will require a relatively large amount of space to accommodate four antenna structures in the mobile phone. Since the manufacture of the mobile phone tends toward compact size, it is considerably difficult to construct a versatile antenna assembly under the restricted given space in the mobile phone.

### SUMMARY OF THE INVENTION

The object of the present invention is to provide a construction design for fabricating an antenna assembly on a flexible base plate such that the antenna assembly can be employed in the mobile phone and the latter can be operated under different communication protocols.

In one aspect of the present invention, an antenna assembly is provided for use in a telecommunication apparatus. The telecommunication apparatus includes a main body provided with a communication module, a cover member for covering the main body, and a battery sandwiched between the cover member and the main body for supplying power source to the communication module. The antenna assembly includes: a base plate adapted to be sandwich between the battery and the cover member; an antenna metal strip unit fabricated on the base plate in order to be sandwiched between the battery and the cover member; an electrical contact unit fabricated on the base plate for establishing electrical communication between the communication module and the antenna metal strip unit; and an etched connecting leg unit for establishing communication between the electrical contact unit and the antenna metal strip unit.

In a second aspect of the present invention, a mobile telecommunication apparatus is provided to include: a main body having a communication module; a cover member for covering the main body; a battery sandwiched between the cover member and the main body for supplying power source to the communication module; and an antenna assembly. The antenna assembly includes: a base plate sandwich between the battery and the cover member, an antenna metal strip unit fabricated on the base plate and sandwiched between the battery and the cover member, an electrical contact unit fabricated on the base plate for establishing electrical communication between the communication module and the antenna metal strip unit, and an etched connecting leg unit for establishing communication between the electrical contact unit and the antenna metal strip unit.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is an exploded view of a conventional telecommunication apparatus;

FIG. 2 is a perspective view of an antenna assembly in the conventional telecommunication apparatus;

FIG. 3 is an exploded view of the first embodiment of a telecommunication apparatus according to the present invention;

FIG. 4 shows a perspective view of an antenna assembly and a battery employed in the first embodiment of the telecommunication apparatus according to the present invention;

FIG. 5 is another partly exploded view of the first embodiment of the telecommunication apparatus according to the present invention; and

FIG. 6 is a partly exploded view of the second embodiment of the telecommunication apparatus according to the present invention.

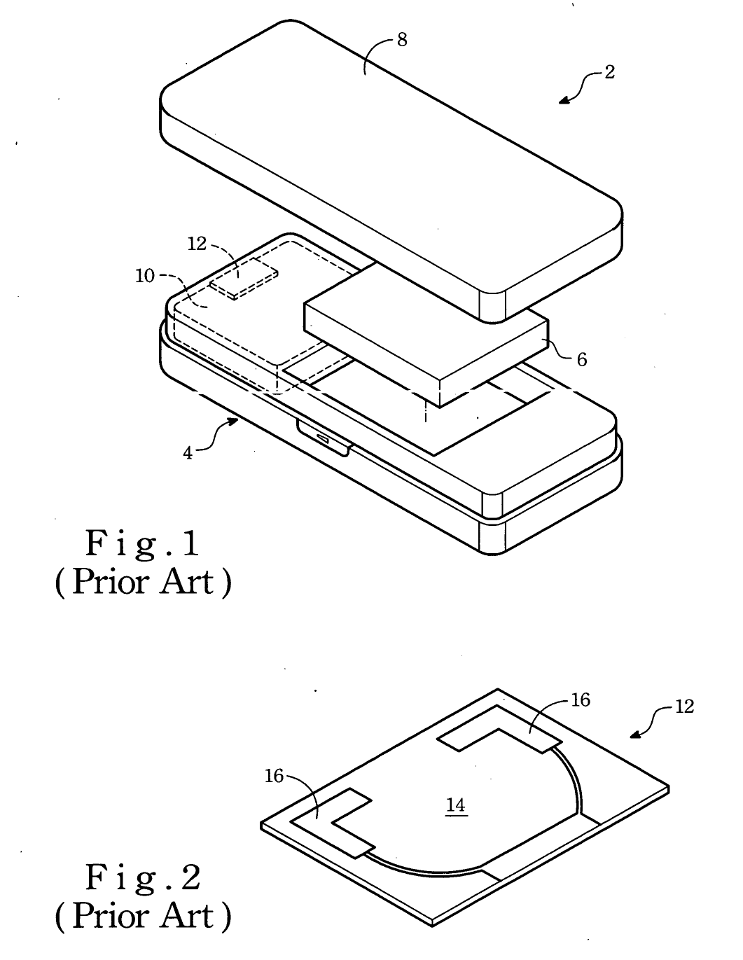

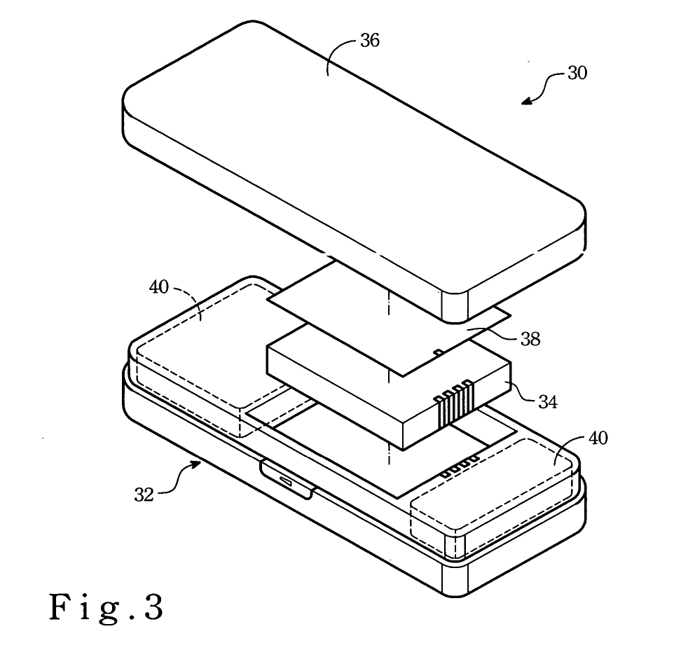

### DETAILED DESCRIPTIONS OF THE PREFERRED EMBODIMENTS

Referring to FIG. 3, an exploded view of the first embodiment of a wireless telecommunication apparatus (hereinafter a mobile phone) according to the present invention is shown to include a main body 32, a cover member 36, a battery 34, and an antenna assembly 38.

The main body 32 has a communication module 40. The cover member 36 is disposed above for covering the main body 32. The battery 34 is sandwiched between the cover member 36 and the main body 32 for supplying power source to the communication module 40.

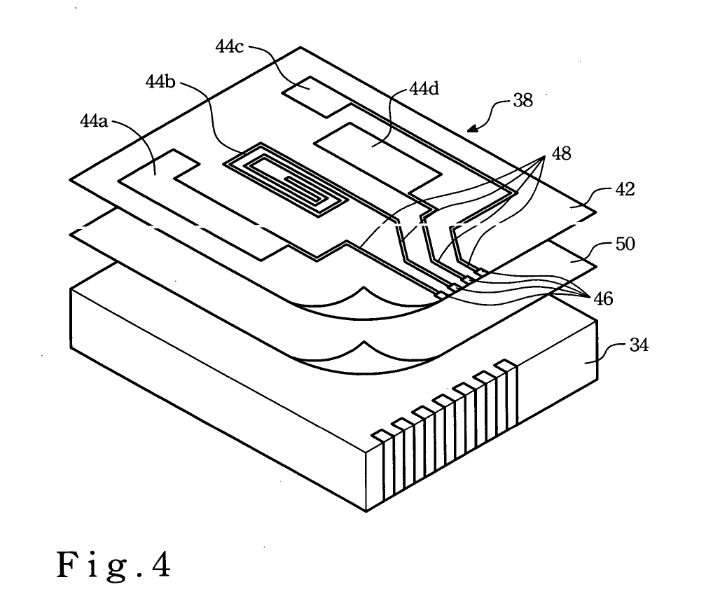

Referring to FIG. 4, the antenna assembly 38 includes a base plate 42, an antenna metal strip unit 44, an electrical contact unit 46, an etched connecting leg unit 48 and a protective membrane 50. The antenna metal strip unit 44 is fabricated on the base plate 42 and is sandwiched between the battery 34 and the cover member 36. The electrical contact unit 46 is fabricated on one end of the base plate 42. The etched connecting leg unit 48 is fabricated on the base plate 42 for establishing communication between the electrical contact unit 46 and the antenna metal strip unit 44. The antenna metal strip unit 44 includes a first metal strip 44a compatible with a digital phone system GSM (Global Sim Mobil), a second metal strip 44b compatible with the GPS (Global Positioning System), a third metal strip 44c compatible with the WLAN (Wireless Local Area Network) and a fourth metal strip 44d compatible with the TV cable. The WLAN is selected from a wireless group including bluetooth protocol, IEEE 802.11a protocol, IEEE 802.11b protocol or IEEE 802.11g protocol.

The protective membrane 50 is disposed between the base plate 42 and the battery 34 for spacing the base plate 42 apart from the battery 34. The main body 32 further includes an electrical connector 54. The battery 34 has a conducting contact unit 52 (including five electrical contacts 53) via which power source of the battery 34 is supplied to the communication module 10. The electrical connector 54 has four antenna-contacting terminals 5402 for coupling with four contacts in the electrical contact unit 46, thereby forming electrical communication between the communication module 40 and the battery 34. In this embodiment, the base plate 42 is made from a flexible substance and is sandwiched between the battery 34 and the cover member 36. Since the flexible base plate 42 is compressible, the latter occupies little space even though its dimension area is relatively large. It is noted that the battery 34 and the electrical connector 54 are provided with a plurality of electrical contacts in order to compatible with the different configuration of the antenna assembly 38. In order to accommodate in the mobile phone of the present invention, each of the antenna metal strips 44a, 44b, 44c and 44d is constructed in a quarter wavelength principle of a transmission frequency.

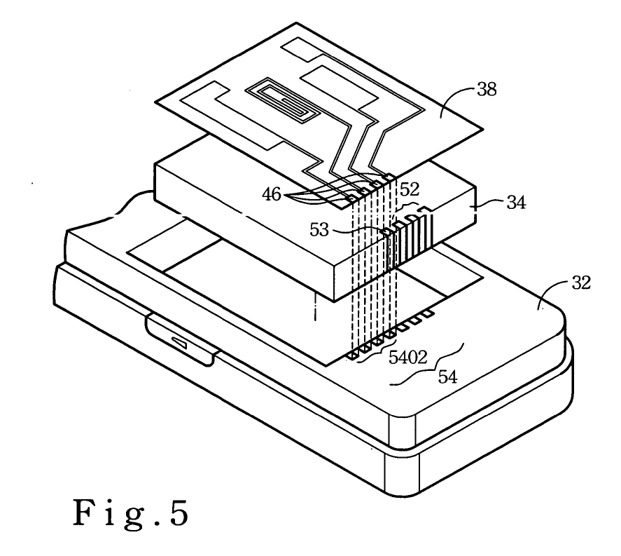

As shown in FIG. 5, once the mobile phone 30 of the present invention is assembled, the electrical contacts in the 53 of the antenna assembly 38 are in electrical communication with the antenna-contact terminals 5402 of the electrical connector 54 via the battery 34 which generally have three contacts 53 (but in the FIG. 5, the battery 34 has an extra contact). Since the antenna-contact terminals 5402 of the electrical connector 54 is in constant communication with the communication module 40, the antenna assembly 38 is therefore in electrically coupled to the communication module 40.

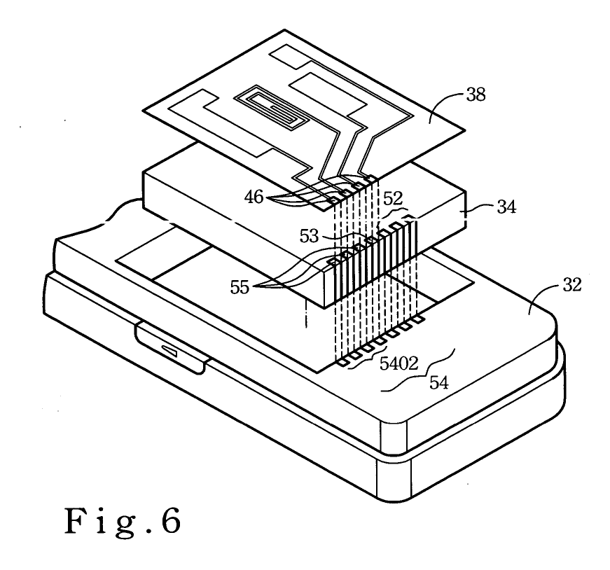

Referring to FIG. 6, a fragmentary exploded view of the second embodiment of the mobile phone is shown to have the construction similar to the previous embodiment. Except that the battery 34 has seven electrical contacts 53, four of which are in registry with four corresponding contacts in the electrical contact unit 46 once the antenna assembly 38 is disposed on the battery 34. After assembly, the mobile phone 30 of the present invention can operate under one of the four-telecommunication protocols.

To summarize the above paragraphs, the present invention provides a construction design to provide four types antennae on the flexible base plate that is to be accommodated within the restricted space of the mobile phone of the present invention.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A mobile telecommunication apparatus comprising:
a main body;
a cover;
a battery disposed between the main body and the cover; and
an antenna assembly disposed between the battery and the cover.

2. The mobile telecommunication apparatus according to claim 1, wherein the antenna assembly includes a base plate disposed between the cover and the battery, and an antenna metal strip formed on the base plate.

3. The mobile telecommunication apparatus according claim 1, further comprising a communication module embedded in the main body.

4. The mobile telecommunication apparatus according to claim 2, wherein the antenna assembly further includes an electrical contact disposed on the base plate and electrically contacting the communication module and an etched connecting leg electrically contacting the antenna metal strip and the electrical contact.

5. A mobile telecommunication apparatus comprising:
a main body having a communication module;
a cover member for covering said main body;
a battery sandwiched between said cover member and said main body for supplying power source to said communication module; and
an antenna assembly including
a base plate sandwiched between said battery and said cover member,
an antenna metal strip unit fabricated on said base plate and sandwiched between said battery and said cover member,
an electrical contact unit fabricated on said base plate for establishing electrical communication between said communication module and said antenna metal strip unit, and
an etched connecting leg unit for establishing communication between said electrical contact unit and said antenna metal strip unit.

6. The mobile telecommunication apparatus according to claim 5, wherein the base plate is made of a flexible material.

7. The mobile telecommunication apparatus according to claim 5, further comprising a protective membrane disposed between said base plate and said battery for spacing said base plate apart from said battery.

8. The mobile telecommunication apparatus according to claim 5, wherein said base plate is made from a flexible substance.

9. The mobile telecommunication apparatus according to claim 5, wherein said main body includes an electrical connector, and wherein said battery has a conducting contact unit via which power source of said battery is supplied to said communication module, said electrical connector having at least one antenna-contacting terminal for coupling with said electrical contact unit, thereby forming electrical communication between said communication module and said battery.

10. The mobile telecommunication apparatus according to claim 5, wherein said antenna assembly is compatible with GPS (Global Sim Mobile) protocol.

11. The mobile telecommunication apparatus according to claim 5, wherein the antenna assembly is compatible with GPS (Global Positioning System).

12. The mobile telecommunication apparatus according to claim 5, wherein the antenna assembly is compatible with WLAN (Wireless Local Area Network) protocol.

13. The mobile telecommunication apparatus according to claim 5, wherein said antenna assembly uses bluetooth protocol for data transmission.

14. The mobile telecommunication apparatus according to claim 5, wherein said antenna assembly uses IEEE 802.11 protocol for data transmission.

15. The mobile telecommunication apparatus according to claim 5, wherein said antenna assembly is compatible with a TV set.

16. The mobile telecommunication apparatus according to claim 5, wherein the antenna assembly is compatible with a quarter wavelength principle of a transmission frequency.
